(19) United States
(12) Patent Application Publication
(10) Pub. No.: US 2003/0094235 A1
(43) Pub. Date: May 22, 2003

(54) Mulitple output reel taper apparatus having linear and push-out reel changer

(75) Inventor: Merlin E. Behnke, Grafton, WI (US)

Correspondence Address: MICHAEL BEST & FRIEDRICH, LLP, 100 E WISCONSIN AVENUE, MILWAUKEE, WI, 53202, US

(73) Assignee: Robotic Vision Systems, Inc., Canton, MA

(21) Appl. No.: 10/165,045

(22) Filed: Jun. 6, 2002

Related U.S. Application Data
(60) Provisional application No. 60/296,674, filed on Jun. 7, 2001.

(51) Int. Cl. B32B 31/00

(52) U.S. Cl. 156/256

(57) ABSTRACT

The present invention provides a multiple output reel module (“MROM”) for use with a taper machine or any other machine outputting flexible media. The MROM includes an upper spindle shaft supporting a plurality of output reels, a lower spindle shaft supporting a plurality of output reels, a tape insertion assembly that positions the flexible media adjacent a hub of one of the output reels along a loading plane, a finger assembly that holds the flexible media against the hub, a cutting assembly for cutting the flexible media, and a reel moving mechanism operable to move the output reels into and out of alignment with the loading plane. The MROM also includes a reel support structure along which the upper and lower spindle shafts are moveable in a linear direction. The flexible media may be held against the hub of the output reels with a finger assembly or a length of adhesive tape. Adhesive tape may also be used to secure the tail end of the flexible media against the last layer of flexible media wound onto a full reel.

This application claims the benefit of U.S. Provisional Patent Application No. 60/296,674, filed Jun. 7, 2001.

### BACKGROUND

The present invention relates to a method and apparatus for automatically replacing a full output reel with an empty output reel in a tape-and-reel machine. Known tape-and-reel machines position electronic parts within the compartments of a carrier tape, and seal a cover tape over the carrier tape to trap the parts within the compartments. As the carrier tape is loaded with parts, it is wound onto an output reel for storage and shipment. The reel is supported by a rotatable spindle.

When the output reel is full of carrier tape, known tape-and-reel machines require the full reel to be removed from the spindle and an empty replacement reel to be mounted onto the same spindle. The machine must be shut down during this reel change-out.

### SUMMARY

The present invention provides a multiple output reel module (“MROM”) for use with a taper machine or any other machine outputting a flexible medium. The MROM includes a spindle shaft supporting a plurality of output reels. The MROM also includes a tape insertion assembly that positions the output medium adjacent the hub of one of the output reels that is aligned with a loading plane, and a finger assembly that holds the output medium against the hub. The output medium is then wound onto the output reel around the hub and a finger of the finger assembly. Once the output reel is full, the output medium is cut, and the full reel is slid along the spindle shaft out of alignment with the loading plane as the next empty reel is moved into alignment with the loading plane. The finger of the finger assembly is thus retracted from the layers of output medium wound onto the reel. The process is then repeated for the next reel.

After all the empty reels on the spindle shaft are full, the spindle shaft and full reels move out of the loading position and into a non-loading position. A second spindle shaft supporting a second plurality of output reels moves from a non-loading position to the loading position so that the empty reels can be loaded with flexible medium in a manner similar to that discussed above. The plurality of output reels that are full and in the non-loading position can be removed from the spindle shaft and replaced with a plurality of empty output reels without interrupting the loading operation of the other spindle shaft.

Other features and advantages of the invention will become apparent to those skilled in the art upon review of the following detailed description, claims, and drawings.

### BRIEF DESCRIPTION OF THE DRAWINGS

FIG. 1 is a side elevation view of a taper machine and a multiple output reel module embodying the present invention.

FIG. 2 is a section view taken along line 2-2 in FIG. 1.

FIG. 3 is an exploded section view of a spindle assembly.

FIG. 4 is an enlarged side view of a portion of the module with a tape insertion assembly in a retracted position.

FIG. 5 is an enlarged side view of the portion of the module with the tape insertion assembly in a loading position.

FIG. 6 is an enlarged view taken along line 6-6 in FIG. 1 of a cutting assembly of the module.

FIG. 7 is an enlarged side view of the cutting assembly.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

The present invention may employ sensors, actuators, dancers, and other components similar to those disclosed in co-pending and commonly-assigned U.S. patent application Ser. No. 09/900,757 filed Jul. 6, 2001. The entire contents of that application are incorporated by reference herein.

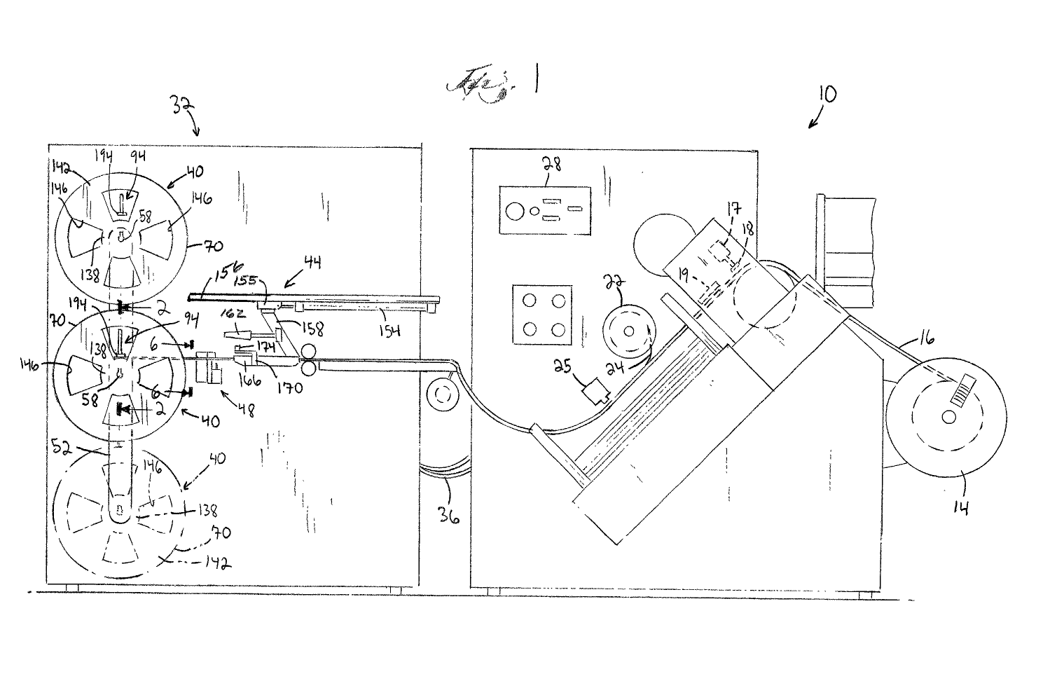

FIG. 1 illustrates a taper machine 10 that includes a reel 14 of carrier tape 16, a pick-and-place head 17 for placing electronic components or parts 18 into the carrier tape 16, a first inspection device 19, a reel 22 of cover tape 24, and a second inspection device 25. The taper machine 10 deposits the parts 18 into compartments of the carrier tape 16 with the pick-and-place head 17, and then inspects electronic components or parts 18 with the first inspection device 19. The taper machine 10 also affixes the cover tape 24 to the carrier tape 16 such that the parts are trapped in the compartments. The taper machine 10 then inspects the carrier tape 16, parts 18, and cover tape 24 with the second inspection device 25 to ensure that the parts 18 are properly sealed in the carrier tape 16. The taper machine 10 includes a central processing unit (“CPU”) 28 that controls the operation of the taper machine 10. It should be noted that, although a taper machine 10 is illustrated, the invention may be used with virtually any machine that outputs a flexible media (e.g., tape, film, rope, cable, etc.) that is to be wound onto reels or spools.

FIG. 1 also illustrates a multiple output reel module (“MROM”) 32 embodying the invention. Wires 36 interconnect the MROM 32 to the CPU 28 on the taper machine 10 in the illustrated construction to coordinate operation of the MROM 32 and taper machine 10. In alternative constructions, a separate CPU may be mounted on-board the MROM 32, and may communicate with the CPU 28 aboard the taper machine 10. Additionally, the MROM 32 may be used with other types of taper machines 10 than the one illustrated, and may receive the flexible media from either the right side (as illustrated) or from the left side. In the event the flexible media is fed to the MROM 32 from the left side, the arrangement of parts would be a substantial mirror image of that shown. It should be noted that the MROM 32 may alternatively be incorporated into the taper machine 10 rather than being a separate, freestanding, modular unit as illustrated.

With continued reference to FIG. 1, the MROM 32 includes upper and lower reel support assemblies 40, a shuttle or tape insertion assembly 44, and a cutoff device or tape cutting assembly 48. The upper and lower reel support assemblies 40 are moveable into and out of a loading position in a linear direction along a reel support structure or track 52, which is in communication with the CPU 28. In the illustrated embodiment, the track 52 is positioned in a vertical orientation, however, the track 52 may be positioned in other orientations such as a horizontal orientation or an angled orientation and still be within the spirit and scope of the present invention. Furthermore, the track 52 may be arcuate or nonlinear in other embodiments.

In FIG. 1, the lower reel support assembly 40 is in the loading position and the upper reel support assembly 40 is in an upper non-loading position. After the upper and lower reel support assemblies 40 move downward along the track 52, the lower reel support assembly 40 is in a lower non-loading position (illustrated in phantom) and the upper reel support assembly 40 is in the loading position. The reels supported by the upper and lower reel support assemblies 40 are in position to be loaded with carrier tape 16 when they are in the loading position.

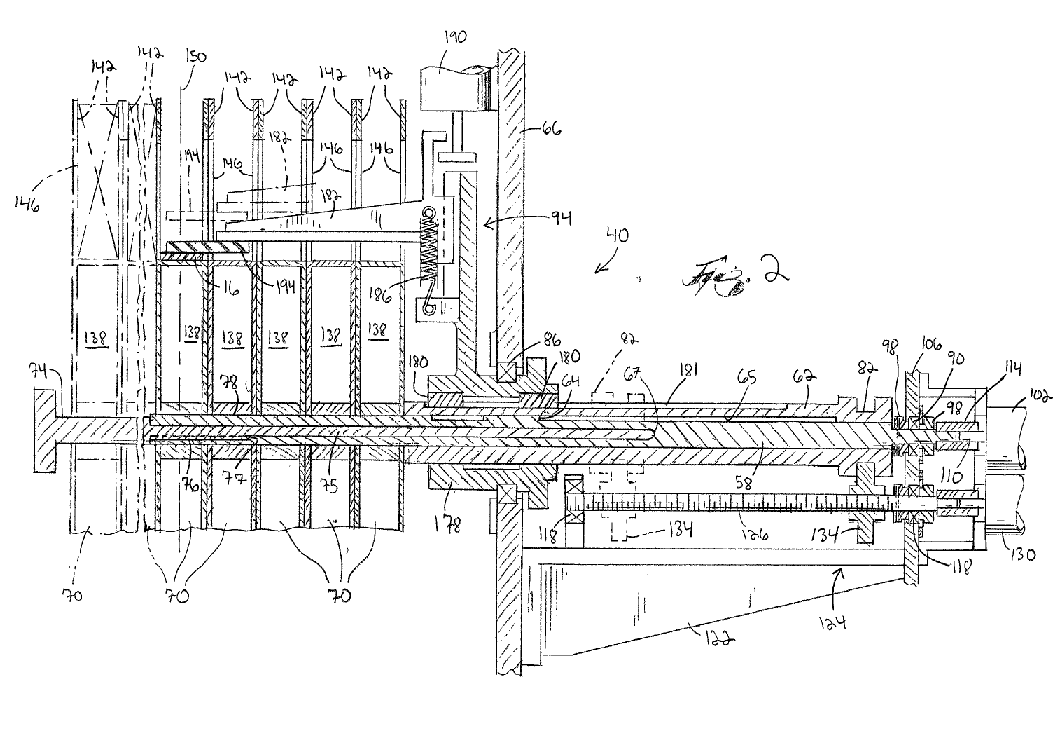

With reference to FIGS. 1-3, the upper and lower reel support assemblies 40 are substantially similar, therefore, only one will be discussed in detail. The reel support assembly 40 includes a spindle shaft 58 and an output reel pusher rod 62 in telescoping relationship with the spindle shaft 58 and slidable therealong. More specifically, the spindle shaft 58 has at least one external spline 64 that engages an internal slot 65 in the pusher rod 62 such that the pusher rod 62 is rotatably coupled to and slidable with respect to the spindle shaft 58. The spindle shaft 58 also includes an aperture 67 and a cantilevered portion that extends away from a support wall 66 and that supports a plurality of output reels 70. The reels 70 are keyed or splined 78 (FIGS. 2-5) to the spindle shaft 58 to cause the reels 70 to rotate with the spindle shaft 58, but to permit the reels 70 to slide longitudinally along the spindle shaft 58. One end of the pusher rod 62 abuts the innermost reel 70. The other end of the pusher rod 62 includes a yoke 82.

The reel support assembly 40 also includes a transition rod 74 connected to the spindle shaft 58 and selectively removable therefrom. The transition rod 74 includes an elongated member 75 that inserts into the aperture 67 in the spindle shaft 58. The elongated member 75 provides support to the transition rod 74 when loaded with full reels 70. The transition rod 74 also includes an external spline 76 that engages an internal slot 77 of the spindle shaft 58 to cause the transition rod 74 to rotate with the spindle shaft 58, but to permit the transition rod 74 to slide longitudinally along the spindle shaft 58.

As illustrated in FIG. 2, the reel support assembly 40 also includes a first bearing 86 and a second bearing 90. The first bearing 86 is press fit into the support wall 66 of the MROM 32, and supports the spindle shaft 58, the pusher rod 62, and a finger assembly 94 for rotation with respect to the wall 66. The second bearing 90 supports the end of the spindle shaft 58 opposite the cantilevered portion. The reel support assembly 40 further includes a pair of collars 98 that are fixed to the spindle shaft 58 with, for example, pins, and abut the inner and outer faces of the second bearing 90 such that the spindle shaft 58 can not substantially move longitudinally.

With continued reference to FIG. 2, the reel support assembly 40 also includes a stepper or servo reel motor 102 that is mounted to a support plate 106 and has an output shaft 110 that is generally in-line with the spindle shaft 58 and that is coupled to the spindle shaft 58 with an anti-backlash coupling 114. The reel support assembly 40 rotates under the influence of the reel motor 102.

The reel support assembly 40 further includes a bridge support 122 mounted to the support wall 66 and an advancing mechanism 124. The advancing mechanism 124 includes a pair of bearings 118 supported by the bridge support 122, a threaded rod or worm gear 126 supported by the pair of bearings 118, a stepper or servo pusher motor 130 coupled to one end of the threaded rod 126 to cause the threaded rod 126 to rotate in a selected direction, and a block 134 threaded onto the threaded rod 126 and engaging the yoke 82 of the pusher rod 62. The pusher motor 130 causes the pusher rod 62 to selectively advance or reciprocate along the spindle shaft 58 in both directions in response to the pusher motor 130 rotating the rod 62. Movement of the pusher rod 62 to the left in FIG. 2 pushes the reels 70 to the left and causes them to slide along the spindle shaft 58 and onto the transition rod 74.

With reference to FIGS. 1 and 2, each output reel 70 includes a hub 138 onto which the carrier tape 16 is wound, and flanges 142 mounted at each end of the hub 138 and defining openings or windows 146. Although there are a plurality of output reels 70 on the spindle shaft 58, only one of the reels 70 is aligned with a loading plane 150 (which is perpendicular to the page in FIG. 2) at a time. When the spindle shaft 58 is loaded with empty reels 70, the outermost reel 70 will be aligned with the loading plane 150 (as illustrated in FIG. 2). The hub 138 of the output reel 70 that is aligned with the loading plane 150 can receive the carrier tape 16 from the taper machine 10.

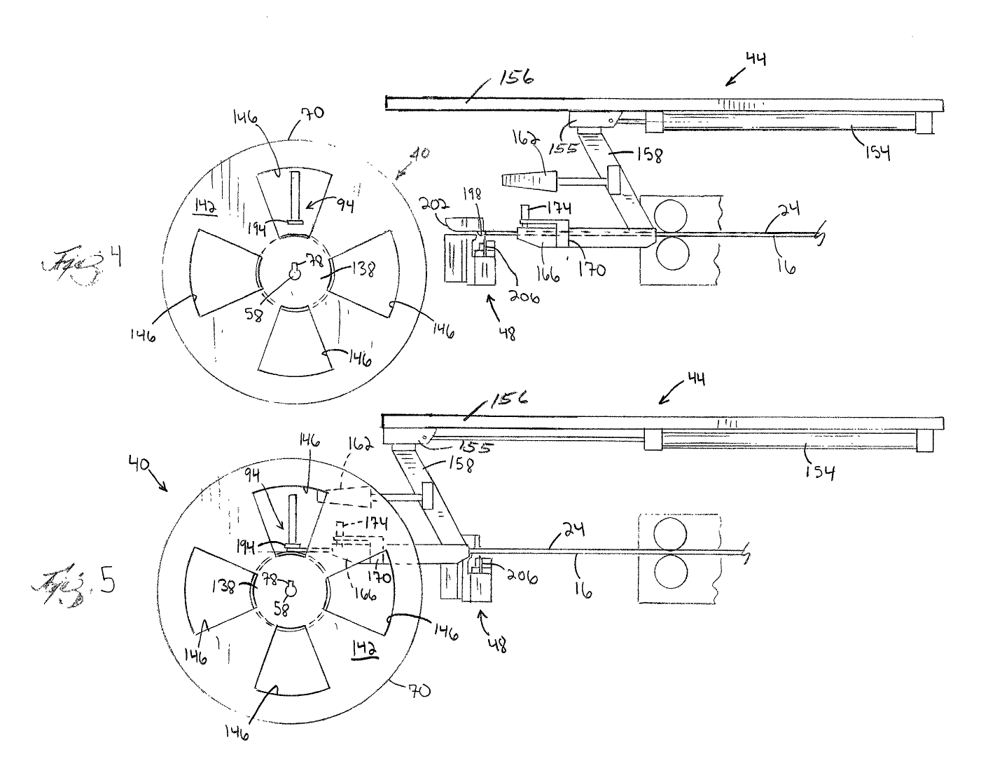

With reference to FIGS. 1, 4, and 5, the tape insertion assembly 44 includes an actuator 154 (e.g., double-acting pneumatic or hydraulic cylinder in the illustrated embodiment) and a slide assembly 155 for moving the tape insertion assembly 44 between a retracted position (illustrated in FIG. 4) and a loading position (illustrated in FIG. 5). The slide assembly 155 is supported in a track 156. The actuator 154 is in communication with a source of compressed air or hydraulic fluid (not shown) in a manner well known to those skilled in the art and, therefore, will not be discussed further herein. The tape insertion assembly 44 also includes an arm 158 supported by the slide assembly 155, a reel spreader 162 coupled to the arm 158, and a pincher or pincher assembly 166. The reel spreader 162 is positioned closer to the reels 70 than the pincher 166 and is wider than the spacing between the reel flanges 142. Therefore, the flanges 142 of the reel 70 aligned with the loading plane 150 bow outwardly when the tape insertion assembly 44 is in the loading position and the reel spreader 162 is inserted between the flanges 142. The flanges 142 are sufficiently outwardly bowed to facilitate insertion of the pincher 166 between the flanges 142 when the tape insertion assembly 44 is in the loading position. The pincher 166 includes a collar 170 through which the carrier tape 16 extends and a pneumatically-actuated or hydraulically-actuated tab 174 mounted to the collar 170. The tab 174 can clamp onto the end of the carrier tape 16 extending out of the taper machine 10.

With reference to FIGS. 1, 2, 4, and 5, the finger assembly 94 includes a base 178 that surrounds a portion of the pusher rod 62, and includes at least one internal spline 180 that engages an external slot 181 in the pusher rod 62 such that the pusher rod 62 is rotatably coupled to and slidable with respect to the finger assembly 94. The finger assembly 94 also includes a tape clamp 182 slidably mounted to the base 178, a biasing spring 186 biasing the clamp 182 toward the base 178 (downwardly as illustrated in FIG. 2), and a clamp lift cylinder 190 mounted to the support wall 66. The lift cylinder 190 selectively lifts the tape clamp 182 against the biasing force of the biasing spring 186 (as illustrated in phantom). The clamp 182 extends through the windows 146 of the reels 70, and includes a finger 194 at its distal end. The finger 194, under the influence of the biasing spring 186, sandwiches the tape 16 against the hub 138 of the reel 70 that is aligned with the loading plane 150. The reel 70 may then be rotated to load the tape 16 onto the reel 70.

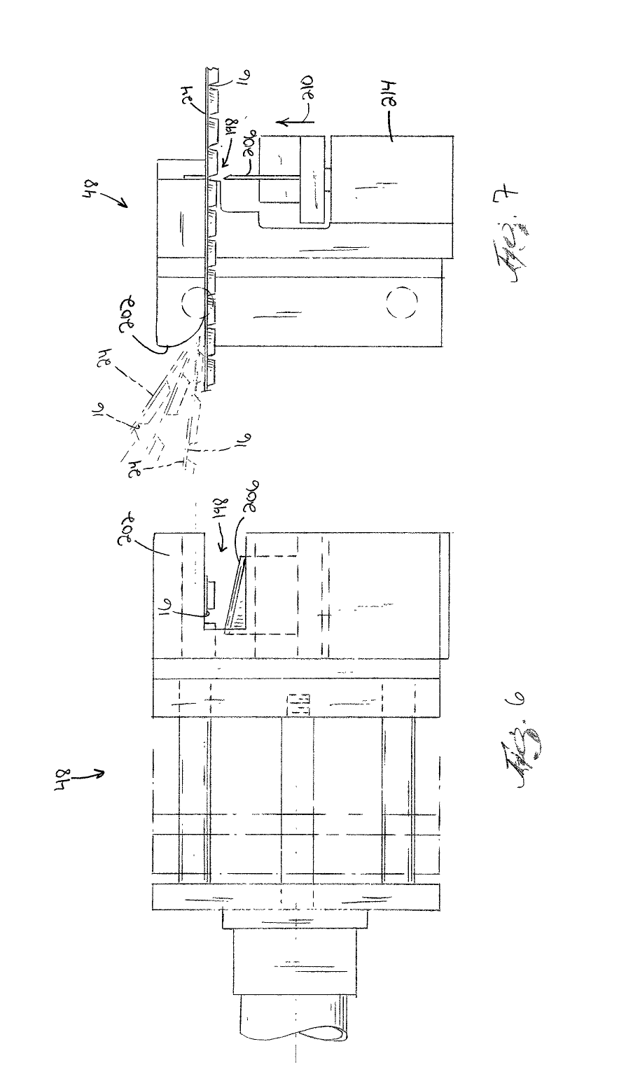

With reference to FIGS. 1 and 4-7, the cutting assembly 48 has an extended position (FIGS. 1, 4, 6, and 7) in which the cutting assembly 48 is positioned between the tape insertion assembly 44 and the reels 70, and a retracted position (FIG. 5 and phantom in FIG. 6) in which the cutting assembly 48 is not between the tape insertion assembly 44 and the reels 70. The cutting assembly 48 is connected to an actuator (e.g., a motor, a pneumatic cylinder, or a hydraulic cylinder) for moving the cutting assembly 48 between the extended and retracted positions. The cutting assembly 48 is in its extended position when the tape insertion assembly 44 is in its retracted position and is moved to its retracted position to allow clearance for the tape insertion assembly 44 to move to its loading position.

The cutting assembly 48 includes a slot 198 through which the carrier tape 16 passes when the cutting assembly 48 is in the extended position, a curved shoe 202, and a cutting element 206 moveable from the retracted position illustrated to an extended position (in the direction of arrow 210 in FIG. 7) to cut the carrier tape 16 when the reel 70 aligned with the loading plane 150 is full of tape. The cutting element is moved between the retracted and extended positions by an actuator 214 (e.g., electric motor, hydraulic cylinder, or pneumatic cylinder). As the reel 70 being loaded with carrier tape 16 is wound with more and more tape, the angle at which the carrier tape 16 exits the cutting assembly 48 increases (illustrated in phantom in FIG. 7). The curved shoe 202 provides a smooth surface with very little friction and no sharp edges to decrease the chance of the carrier tape 16 breaking, being weakened, or being damaged.

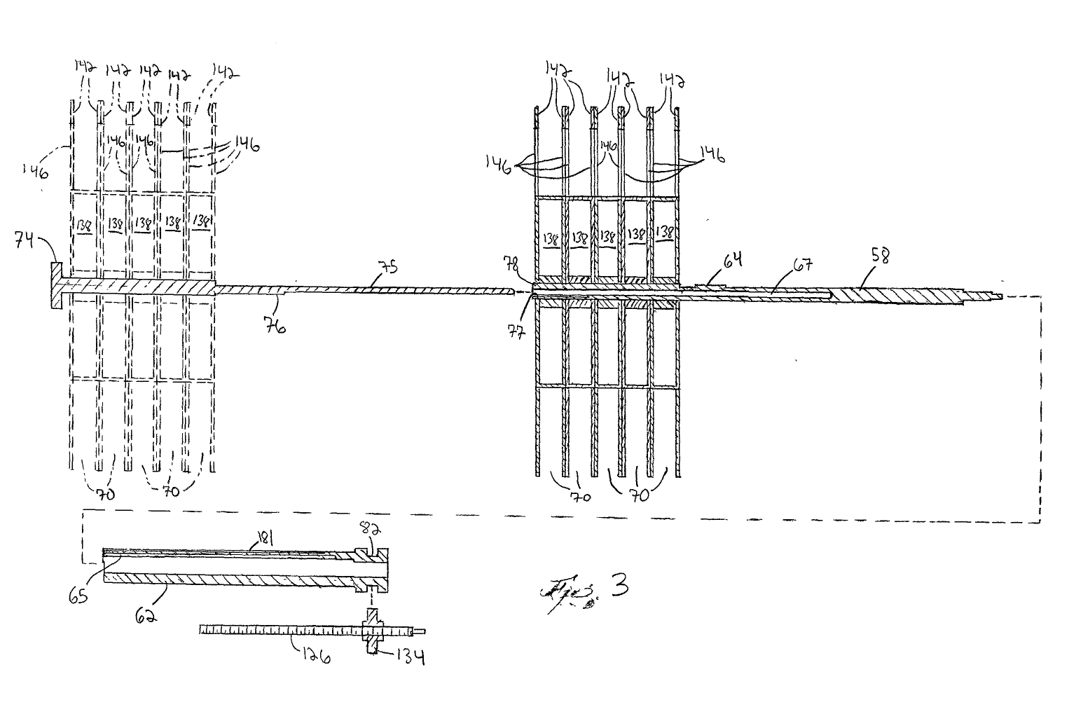

The operation of the MROM 32 will now be described. Except where indicated, all steps are controlled by the CPU 28 and are executed using motors or other actuators under the control of the CPU 28. The upper and lower spindle shafts 58 are first manually loaded with empty output reels 70 (as illustrated in FIG. 3), and the MROM 32 and taper machine 10 are activated. The tape 16 is pinched by the tab 174 of the pincher 166 to prevent the tape 16 from falling out or off of the pincher 166. The cutting assembly 48 moves to the retracted position and the tape insertion assembly 44 moves from the retracted position to the loading position, this occurs as the taper machine 10 continues to advancing sealed carrier tape toward the MROM 32. The reel spreader 162 inserts between the flanges 142 of the reel 70 aligned with the loading plane 150 and bows the flanges 142 outwardly to facilitate insertion of the pincher 166 between the flanges 142. The end of the tape 16 is positioned and held adjacent to the hub 138 of the reel 70 aligned with the loading plane 150 by the pincher 166.

Then the clamp lift cylinder 190 is deactivated to permit the clamp 182 of the finger assembly 94 to be biased downwardly by the biasing spring 186. The finger 194 engages the end of the tape 16 and sandwiches it against the hub 138 of the reel 70. The tab 174 is retracted, and the tape insertion assembly 44 is then retracted, thereby leaving the tape 16 held against the reel 70 by the finger 194. When the process is working within the same multi-reel spindle, there is no downtime on the taping machine. This design reduces machine operation downtime and increases part output (measured in units-per-hour or “uph”) and throughput of the system. The cutting assembly 48 then moves to the extended position and the carrier tape 16 continues to slide through the slot 198. It should be noted that an operator may have to manually position the end of the tape 16 in the tape insertion assembly 44 for loading the first reel 70.

After the first empty reel machine cycle is completed, the taper machine 10 will not have to stop except when it is necessary to move the reel support assemblies 40 into and out of the loading position. The taper machine 10 can continue inspecting parts and depositing the good parts in the carrier tape compartments. The cover tape 24 is applied to the carrier tape 16, and the populated tape is fed into the MROM 32. The CPU 28 activates the reel motor 102 when enough slack is present in the tape 16 between the MROM 32 and the taper machine 10. A dancer or other suitable device utilizing either mechanical or photo-optic switches may be used to monitor the slack in the tape 16. The spindle shaft 58, finger assembly 94, pusher rod 62, and transition rod 74 rotate in response to operation of the reel motor 102, and the tape 16 is wound onto the reel 70 over the finger 194. Alternatively, the reel motor 102 may be programmed to rotate at the rate the tape 16 passes through the taper machine 10, or may be controlled by the CPU 28 to be coordinated with the output of the taper machine 10.

Any suitable sensor may be used to determine when the reel 70 is full of the carrier tape 16. In lieu of a sensor, the CPU 28 may determine when a reel 70 is full by counting the number of carrier tape pockets that have been filled. Once the reel 70 is full, the CPU 28 activates the tab 174 to take custody of the tape being discharged by the taper machine 10. The CPU then activates the actuator 214 to cut the tape 16 with the cutting element 206. The clamping and cutting are done on the fly as the taper machine 10 continues its taping process and as the reel 70 completes its last revolution to take up the tail end of the tape 16. Once the tape 16 is cut, the cutting element 206 returns to the retracted position. Any suitable cutting assembly may be used to cut the tape 16 between the tape insertion assembly 44 and the reel 70 and still be within the spirit and scope of the present invention, and the invention is therefore not limited to the illustrated construction.

The reel motor 102 stops the rotation of the reel 70 when the clamp lift cylinder 190 is aligned with the finger assembly 94. Suitable sensors and gates may be employed to ensure that the clamp 182 is aligned with the lift cylinder 190. Then the pusher motor 130 is activated to rotate the threaded rod 126. The block 134 travels linearly along the threaded rod 126 in response to rotation of the threaded rod 126, which in turn causes the pusher rod 62 to move linearly along the spindle shaft 58. The pusher rod 62 pushes the outermost reel 70 out of, and the next reel 70 into, alignment with the loading plane 150. The outermost reel 70 is pushed onto the transition rod 74. The finger 194 is thereby retracted from the layers of tape 16 that have been wound around it as the reel 70 is moved to the left in FIG. 2. The finger 194 is now positioned over the hub 138 of the next reel 70, which is now aligned with the loading plane 150.

The clamp lift cylinder 190 is then activated to raise the clamp 182 and finger 194. As the end of the freshly-cut sealed carrier tape 16 is moved into position under the finger 194, the clamp lift cylinder is de-activated, thereby clamping the carrier tape to the hub of the empty reel under the finger 194. Once the finger 194 has custody of the tape 16, the tab 174 is released and the tape insertion assembly retracts to its starting position. At the same time, the reel motor 102 rotates the reel 70 in time with the rate of the taper machine 10 output, and faster than the taper machine 10 output if there is too much slack in the tape 16. The tape cutting assembly 48 then moves forward into the position shown in solid lines in FIGS. 6 and 7.

The above process is then repeated, until all output reels 70 on the lower reel support assembly 40 are full and to the left of the plane 150 as is seen in FIGS. 2 and 3 in phantom. Then the lower support assembly 40 is moved from the loading position to the lower non-loading position and the upper support assembly 40 is moved from the upper non-loading position to the loading position by the CPU 28. The empty reels 70 on the upper reel support assembly 40 are loaded in a manner substantially identical to the manner described above for the reels 70 on the lower reel support assembly 40, and the above process for loading the empty reels 70 is repeated until all the reels 70 on the upper reel support assembly 40 are full.

After the lower reel support assembly 40 is moved to the lower non-loading position, the transition rod 74 may be removed from the lower spindle shaft 58, along with the full reels 70. The full reels 70 may then be packaged and a new set of empty output reels 70 may be slid onto the lower spindle shaft 58. It should be noted that the reel change-out on the lower reel support assembly 40 can be done without interrupting the tape winding process on the upper reel support assembly 40 and vice-versa.

After all the reels 70 on the upper reel support assembly 40 are full, the CPU 28 moves the upper reel support assembly 40 from the loading position to the upper non-loading position and moves the lower reel support assembly 40 from the lower non-loading position to the loading position where the process of loading the empty reels 70 repeats. The transition rod 74 may be removed from the upper spindle shaft 58, along with the full reels 70, and a new set of empty output reels 70 may be slid onto the upper spindle shaft 58. The entire process can be repeated as desired and the only time that there is interruption to the taper machine process is when the supply of carrier or cover tape 16, 24 or parts 18 runs out, or when the support assemblies 40 move vertically into and out of the loading position. Even when the support assemblies 40 are moved, however, the taper machine 10 may continue to output tape, provided the CPU 28 is programmed to take up the slack when the new empty reels 70 are in place.

It should be noted that, once the tape 16 is initially manually connected to the pincher 166, the MROM 32 maintains custody of the tape 16 at all times with either the tab 174 or the finger 194. The need for user intervention is therefore greatly reduced in the present invention.

In an alternative embodiment, the MROM 32 may be provided with only one reel support assembly 40, and not include the track 52. In that case, the MROM would only be able to load the plurality of reels 70 supported by the single support assembly 40, and the reels 70 would have to be manually changed out when all of the reels 22 on the support assembly 40 are full of tape.

In an alternative construction of the MROM 32, the finger assembly 94 may be eliminated and replaced with an adhesive tape dispenser module. In this construction, when the free end of the carrier tape is positioned adjacent the reel hub, the adhesive tape dispenser bridges a length of adhesive tape across the end of the carrier tape and a portion of the hub. The end of the carrier tape is thereby secured to the reel hub so that the carrier tape may be wound onto the reel. The adhesive tape dispenser may also be used to secure the tail end of the sealed carrier tape to the top of the previously-wound layer of carrier tape on the full reel, whether the finger assembly 94 or an adhesive tape is used on the inner end of the carrier tape 16.

Although particular constructions of the present invention have been shown and described, other alternative constructions will be apparent to those skilled in the art and are within the intended scope of the present invention.

1. An apparatus for packaging flexible media onto a plurality of output reels, the apparatus comprising:
a rotary actuator for loading one of the output reels with media while the reel is in a loading position; and
a reel support structure for linearly moving a full reel out of the loading position and moving another of the plurality of output reels into the loading position.

2. The apparatus as claimed in claim 1, wherein the flexible media is carrier tape.

3. The apparatus as claimed in claim 1, further comprising an insertion assembly for automatically inserting media adjacent to the reel in the loading position.

4. The apparatus as claimed in claim 3, wherein the insertion assembly includes a pincher for pinching the flexible media.

5. The apparatus as claimed in claim 3, further comprising a cutoff device for cutting the flexible media when one of the plurality of output reels aligned with the loading plane is loaded with flexible media, and wherein the insertion assembly has a loading position in which the insertion assembly is loading the flexible media onto one of the plurality of output reels and a retracted position in which the insertion assembly is not loading the flexible media onto one of the plurality of output reels, the cutoff device being retractable when the insertion assembly is moving between the loading position and the retracted position.

6. The apparatus as claimed in claim 3, wherein the insertion assembly is movable between an extended position in which the insertion assembly positions the flexible media adjacent the output reel in the loading position and a retracted position in which the insertion assembly is moved away from the output reels.

7. The apparatus as claimed in claim 6, wherein the plurality of output reels include flanges and the insertion assembly includes a pincher for pinching the flexible media and a spreader that spreads the flanges when the insertion assembly is in the extended position to facilitate advancing the pincher between the flanges.

8. The apparatus as claimed in claim 1, wherein the reel support structure includes a track to facilitate the linear movement of the output reels.

9. The apparatus as claimed in claim 1, further comprising a finger assembly for selectively clamping a leading edge of the flexible media to one of the plurality of output reels.

10. The apparatus as claimed in claim 1, further comprising a cutoff device for cutting the flexible media when the output reel aligned with the loading position is loaded with flexible media.

11. The apparatus as claimed in claim 1, further comprising:
first and second spindles, each supporting some of the plurality of reels, the spindles movable into and out of the loading position; and
a pusher assembly pushing the reels on the spindle shaft in the loading position into and out of alignment with a loading plane to permit sequential loading of the reels on the spindle in the loading position.

12. An apparatus for packaging flexible media, the apparatus comprising:
a first spindle shaft adapted to support a first plurality of output reels, the first plurality of output reels and the first spindle shaft being rotatable together;
a second spindle shaft adapted to support a second plurality of output reels, the second plurality of output reels and the second spindle shaft being rotatable together;
a reel support structure connected to the first and second spindle shafts and operable to move the first and second spindle shafts into and out of a loading position;
an insertion assembly for inserting flexible media adjacent the output reel that is aligned with a loading plane and that is supported by the spindle in the loading position; and
a reel moving mechanism engageable with the output reels on the spindle shaft in the loading position, the reel moving mechanism operable to move the output reels into and out of alignment with the loading plane.

13. The apparatus as claimed in claim 12, wherein the flexible media is carrier tape.

14. The apparatus as claimed in claim 12, wherein the reel support structure is a track along which the first and second spindle shafts can move linearly.

15. The apparatus as claimed in claim 12, wherein the insertion assembly includes a pincher for pinching the flexible media.

16. The apparatus as claimed in claim 12, wherein the insertion assembly has an extended position in which the insertion assembly is loading the flexible media onto the output reel in the loading plane and a retracted position in which the insertion assembly is moved away from the output reels.

17. The apparatus as claimed in claim 16, wherein the first and second pluralities of output reels include flanges and wherein the insertion assembly includes a pincher for pinching the flexible media and a spreader that spreads the flanges when the insertion assembly is in the extended position to facilitate advancing the pincher between the flanges.

18. The apparatus as claimed in claim 12, further comprising a finger assembly for selectively clamping a leading edge of the flexible media to one of the first plurality of output reels or one of the second plurality of output reels.

19. The apparatus as claimed in claim 12, wherein the reel moving mechanism includes a pusher rod that is engageable with at least one of the first plurality of output reels or one of the second plurality of output reels.

20. The apparatus as claimed in claim 19, wherein the reel moving mechanism includes an advancing mechanism for advancing the pusher rod against at least one of the first plurality of output reels or at least one of the second plurality of output reels.

21. The apparatus as claimed in claim 20, wherein the advancing mechanism includes a motor operably interconnected with a threaded shaft and a collar movable along the threaded shaft in response to rotation of the threaded shaft by the motor.

22. The apparatus as claimed in claim 12, further comprising a cutoff device for cutting the flexible media when the reel that is aligned with the loading plane is loaded with flexible media.

23. The apparatus as claimed in claim 22, wherein the insertion assembly has an extended position in which the insertion assembly is loading the flexible media onto the output reel in the loading plane and a retracted position in which the insertion assembly is moved away from the output reels, the cutoff device being retractable to accommodate moving the insertion assembly into the extended position.

24. An apparatus for packaging flexible media, the apparatus comprising:
a spindle shaft adapted to support a plurality of output reels, the plurality of output reels and the spindle shaft being rotatable together;
a rotary actuator for rotating the spindle shaft and for thereby loading the flexible media onto one of the plurality of output reels that is aligned with a loading plane; and
a reel moving mechanism engageable with at least one of the plurality of output reels on the spindle shaft for moving one output reel out of alignment with the loading plane and another output reel into alignment with the loading plane.

25. The apparatus as claimed in claim 24, wherein the flexible media is carrier tape.

26. The apparatus as claimed in claim 24, further comprising an insertion assembly for automatically inserting media adjacent to the reel in the loading position.

27. The apparatus as claimed in claim 26, wherein the insertion assembly includes a pincher for pinching the flexible media.

28. The apparatus as claimed in claim 26, wherein the insertion assembly has an extended position in which the insertion assembly positions the flexible media adjacent the reel in the loading plane and a retracted position in which the insertion assembly is retracted with respect to the reels.

29. The apparatus as claimed in claim 28, wherein the plurality of output reels include flanges, and the insertion assembly includes a pincher for pinching the flexible media, the insertion assembly also including a spreader that spreads the flanges to enable the pincher to advance between the flanges.

30. The apparatus as claimed in claim 24, further comprising a finger assembly for selectively clamping a leading edge of the flexible media to the output reel in the loading plane.

31. The apparatus as claimed in claim 24, wherein the reel moving mechanism includes a pusher rod that abuts at least one of the plurality of the output reels.

32. The apparatus as claimed in claim 31, wherein the reel moving mechanism includes an advancing mechanism for advancing the pusher rod against one of the plurality of output reels to move one of the reels out of alignment with the loading plane and to move another of the reels into alignment with the loading plane.

33. The apparatus as claimed in claim 24, further comprising a cutoff device for cutting the flexible media when the reels aligned with the loading plane is loaded with flexible media.

34. The apparatus as claimed in claim 33, wherein the insertion assembly has an extended position in which the insertion assembly is loading the flexible media onto one of the plurality of output reels and a retracted position in which the insertion assembly is not loading the flexible media onto one of the plurality of output reels, the cutoff device being retractable to permit the insertion assembly to move to the extended position.

35. The apparatus as claimed in claim 24, wherein the spindle shaft is a first spindle shaft, the apparatus further comprising a second spindle shaft adapted to support a second plurality of output reels and a spindle moving assembly for moving the first spindle shaft out of a loading position when all reels supported on the first spindle shaft are loaded with media and for moving the second spindle shaft into the loading position.

36. The apparatus as claimed in claim 35, wherein the spindle moving assembly includes a linear track for moving the first and second spindle shafts into and out of the loading position linearly.

37. A method of packaging flexible media, the method comprising:
supporting first and second output reels on a first spindle in a loading position;
supporting third and fourth output reels on a second spindle in a first non-loading position; aligning the first reel with a loading plane and
loading flexible media onto the first output reel;
moving the first output reel along the first spindle and out of alignment with the loading plane when the first output reel is loaded with flexible media and moving the second output reel along the first spindle and into alignment with the loading plane;
loading flexible media onto the second output reel;
moving the first spindle in a linear direction from the loading position to a second non-loading position after the second output real is loaded with flexible media;
moving the third and fourth output reels from the first non-loading position to the loading position;
aligning the third output reel with the loading plane;
loading flexible media onto the third output reel; and
moving the third output reel along the second spindle and out of alignment with the loading plane when the third output reel is loaded with flexible media and moving the fourth output reel along the second spindle and into alignment with the loading plane.

38. The method of claim 37, wherein said loading steps include automatically positioning an end of the flexible media adjacent the reel in the loading plane and rotating the reel to wind the flexible media thereon.

39. The method of claim 37, wherein the steps of moving the respective reels out of alignment includes pushing the reels on the spindle in the loading position to move the reels along the spindle.
